(19) United States
(12) Patent Application Publication
(10) Pub. No.: US 2015/0329372 A1
(43) Pub. Date: Nov. 19, 2015

(54) TITANIUM DIOXIDE PRODUCTION, AND METHODS OF CONTROLLING PARTICLE SIZE THEREOF

(71) Applicant: Cristal Inorganic Chemicals Switzerland Ltd, Baar (CH)

(72) Inventors: Bela Derecskei, Glen Burnie, MD (US); Mark D. Pomponi, Ellicott, MD (US); Venkata R. Sama, Parkville, MD (US)

(73) Assignee: Cristal Inorganic Chemicals Switzerland Ltd

(21) Appl. No.: 14/812,280

(22) Filed: Jul. 29, 2015

Related U.S. Application Data
(63) Continuation of application No. PCT/US2014/014190, filed on Jan. 31, 2014.
(60) Provisional application No. 61/759,275, filed on Jan. 31, 2013.

(51) Int. Cl. C01G 23/07

(52) U.S. Cl. CPC C01G 23/07

(57) ABSTRACT

Disclosed is a method/system for the production of titanium dioxide particles. The titanium dioxide particles are produced by oxidizing titanium tetrachloride in the presence of an agent which includes ultrafine titanium dioxide particles, and optionally, the presence of a Group 1a metal compound. The presence of the agent, with or without the optional Group 1a metal compound, also serves to control the particle size of the produced titanium dioxide particles.

### FIELD OF THE INVENTION

The presently disclosed and claimed inventive process(es), procedure(s), method(s), product(s), result(s) and/or concept(s) (collectively hereinafter referenced to as the “presently disclosed and claimed inventive concept(s)”) generally relates to methods and systems for producing titanium dioxide. More specifically, the presently disclosed and claimed inventive concept(s) relates to methods for controlling particle size during the production of such titanium dioxide.

### BACKGROUND OF THE INVENTION

Potassium chloride (KCl) is commonly used as an agent in the chloride-based process for producing titanium dioxide in order to control titanium dioxide particle size. The agent can act as a nucleating agent or as a non-agglomerating agent or both as a nucleating agent and as a non-agglomerating agent. Amounts of KCl ranging from 10 ppm to 1000 ppm, based on the weight of titanium dioxide, have been considered useful in obtaining pigmentary particle size with desirable millability and bulk density. While KCl is generally useful in reducing titanium dioxide particle size, it has been observed that the incremental effectiveness of KCl tends to decrease with increasing amounts of KCl added. Cesium chloride (CsCl) can be used instead of KCl as the agent in order to retain particle size reduction effectiveness under a broader range of process conditions than are possible with the use of KCl. However, CsCl is more than 20 times as expensive as KCl, making the use of CsCl to control titanium dioxide particle size cost prohibitive in many circumstances.

Accordingly, there remains a need for an improved method and system for controlling the particle size of titanium dioxide produced using the chloride-based process which is effective under a variety of process conditions and is also cost effective.

### SUMMARY OF THE INVENTION

In accordance with an embodiment of the presently disclosed and claimed inventive concept(s), a method for producing titanium dioxide particles is provided and comprises:

a) introducing titanium tetrachloride, oxygen, and an agent to an oxidizer, wherein the agent comprises ultrafine titanium dioxide particles; and wherein the ultrafine titanium dioxide particles can be in a form selected from the group consisting of anatase, rutile, amorphous, and combinations thereof; and

b) oxidizing at least some of the titanium tetrachloride with at least some of the oxygen in the presence of the agent to form an oxidizer effluent comprising a titanium dioxide product having titanium dioxide particles. Optionally, a Group 1a metal compound can also be introduced into the oxidizer.

In accordance with an embodiment of the presently disclosed and claimed inventive concept(s), a method for controlling particle size of titanium dioxide particles is provided and comprises:

a) introducing titanium tetrachloride and oxygen to an oxidizer;

b) introducing an agent comprising ultrafine titanium dioxide particles to the oxidizer in a controlled manner, wherein the ultrafine titanium dioxide particles can be in a form selected from the group consisting of anatase, rutile, amorphous, and combinations thereof; and

c) oxidizing at least some of the titanium tetrachloride with at least some of the oxygen in the presence of the agent to form an oxidizer effluent comprising a titanium dioxide product having titanium dioxide particles, and wherein the introduction of the agent to the oxidizer is controlled such that, at a target titanium dioxide rate of production, the manufacturing costs are lower and/or the titanium dioxide product has a lower median titanium dioxide particle size and/or a narrower particle size distribution as compared to a second titanium dioxide product produced by a method which is the same as that used to produce the titanium dioxide product, but without the controlled introduction of the agent to the oxidizer.

In accordance with an embodiment of the presently disclosed and claimed inventive concept(s), a method for producing titanium dioxide particles is provided and comprises:

a) introducing oxygen and a first titanium tetrachloride feed comprising titanium tetrachloride to a first stage of an oxidizer having at least two stages;

b) oxidizing at least some of the first titanium tetrachloride feed with at least some of the oxygen in the first stage to form a first stage effluent;

c) introducing the first stage effluent to a second stage of the oxidizer;

d) introducing a second titanium tetrachloride feed comprising titanium tetrachloride to the second stage;

e) oxidizing at least some of the second titanium tetrachloride feed with at least some of the oxygen from the first stage effluent in the second stage to form a second stage effluent comprising a titanium dioxide product, wherein the titanium dioxide product comprises the titanium dioxide particles; wherein an agent comprising ultrafine titanium dioxide particles is introduced to at least one stage of the oxidizer; and

f) separating at least some of the titanium dioxide product from the second stage effluent.

### BRIEF DESCRIPTION OF THE FIGURES

FIG. 1 is a schematic diagram of an oxidizer process/system useful in the production of titanium dioxide products in accordance with the presently disclosed and claimed inventive concept(s).

FIG. 2 is a schematic diagram of an oxidizer process/system having at least two stages useful in the production of titanium dioxide products in accordance with the presently disclosed and claimed inventive concept(s).

FIG. 3 is a plot of the normalized particle size for titanium dioxide product produced in an oxidizer vs. the ultrafine TiO₂ addition rate to the oxidizer, related to the example.

### DETAILED DESCRIPTION OF THE INVENTION

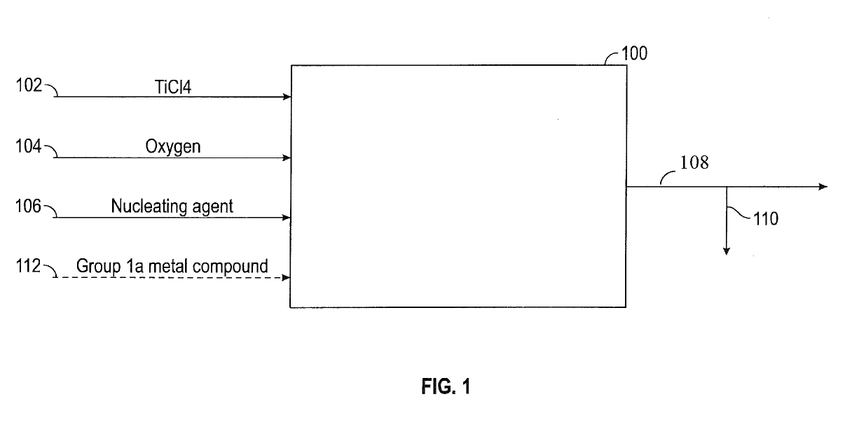

Titanium dioxide can be produced by a process called the “chloride-based process”. In the chloride-based process, a titanium halide, like titanium tetrachloride, is oxidized in an oxidizer to form titanium dioxide particles. With reference to FIG. 1, and in accordance with an embodiment of the presently disclosed and claimed inventive concept(s), titanium dioxide particles are produced by a method comprising, consisting of, or consisting essentially of:

a) introducing titanium tetrachloride, oxygen, and an agent to an oxidizer 100 (which can comprise a single stage or multiple stages), via lines 102, 104 and 106, respectively, wherein the agent comprises ultrafine titanium dioxide particles; and wherein the ultrafine titanium dioxide particles are in a form selected from the group consisting of anatase, rutile, amorphous, and combinations thereof; and

b) oxidizing at least some of the titanium tetrachloride with at least some of the oxygen in the presence of the agent to form an oxidizer effluent 108 comprising a titanium dioxide product having titanium dioxide particles. At least some of the titanium dioxide product can be separated from the oxidizer effluent 108 via line 110, and the oxidizer 100 can be operated at a temperature in the range of from about 900° C. to about 1600° C., or at a temperature in the range of from about 1200° C. to about 1600° C.

In accordance with embodiments of the presently disclosed and claimed inventive concept(s) the agent disclosed herein can act as a nucleating agent or as a non-agglomerating agent or both as a nucleating agent and as a non-agglomerating agent. The agent is not restricted to providing both nucleating and non-agglomerating activity and is also not restricted to providing only nucleating activity or only non-agglomerating activity. It should be understood that multiple agents can be used in accordance with embodiments of the presently disclosed and claimed inventive concept(s), and that each such agent may provide nucleating activity or non-agglomerating activity or both nucleating and non-agglomerating activity, and that one such agent can provide nucleating activity while another agent provides non-agglomerating activity.

The ultrafine titanium dioxide particles of the agent can be in a form selected from the group consisting of a sol, solids, suspended solids, and combinations thereof. The ultrafine titanium dioxide particles can be present as discrete particles or as agglomerates, as further described below. The titanium tetrachloride can be introduced to the oxidizer 100 as a vaporous or as a liquid feed. At least some of the ultrafine titanium dioxide particles can be combined with the titanium tetrachloride prior to the introduction of the titanium tetrachloride to the oxidizer 100, and/or combined with the oxygen prior to the introduction of the oxygen to the oxidizer 100.

At least some of the ultrafine titanium dioxide particles can be introduced to the oxidizer 100 upstream of the introduction of the titanium tetrachloride to the oxidizer 100, and/or introduced to the oxidizer 100 downstream of the introduction of the titanium tetrachloride to the oxidizer 100. The ultrafine titanium dioxide particles can be introduced to the oxidizer 100 in an amount of from about 50 ppmw to about 100 ppmw, or from about 60 ppmw to about 90 ppmw, or from about 65 ppmw to about 80 ppmw, based on the total weight of the titanium dioxide particles produced in step b). In accordance with an embodiment, at least a portion of the ultrafine titanium dioxide particles can be in the form of agglomerated ultrafine titanium dioxide particles, and the median size of such agglomerated ultrafine titanium dioxide particles can range from about 2 nm to about 150 nm, or from about 5 nm to about 80 nm, or from about 30 nm to about 60 nm. In accordance with an embodiment, at least a portion of the ultrafine titanium dioxide particles are in the form of discrete ultrafine titanium dioxide particles, and the median discrete particle size of such discrete ultrafine titanium dioxide particles can range from about 1 nm to about 60 nm, or from about 1 nm to about 10 nm. The ultrafine titanium dioxide particles can be produced from either the chloride-based process or a sulfate-based titanium dioxide production process.

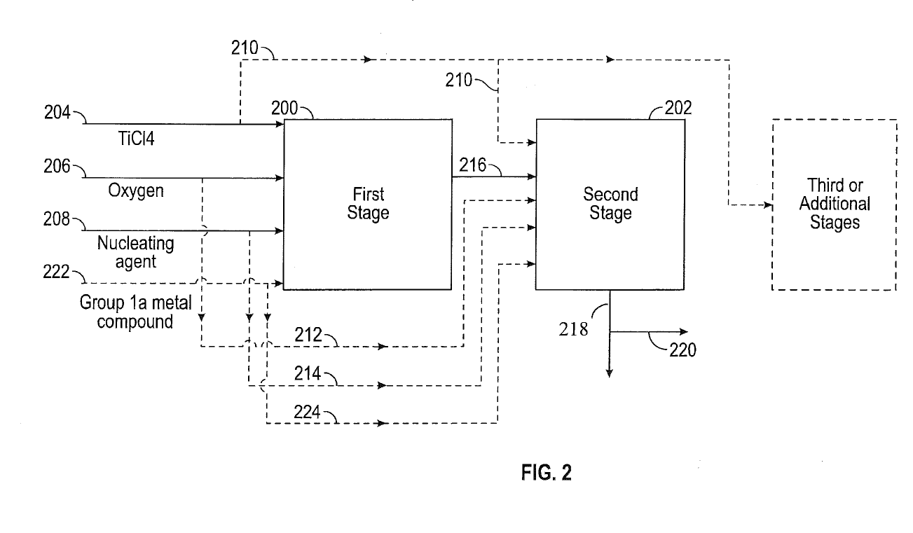

With reference to FIG. 2, the oxidizer can comprise at least a first stage 200 and a second stage 202. At least some of the titanium tetrachloride, at least some of the oxygen, and at least some of the agent can be introduced to the first stage 200 via lines 204, 206 and 208, respectively. In addition, at least some of the titanium tetrachloride can be introduced to the second stage 202 via lines 204 and 210. The first stage 200 can be operated at a temperature in the range of from about 900° C. to about 1600° C., and the second stage 202 can be operated at a temperature which is the same as, lower than, or higher than the temperature of the first stage 200, and/or the second stage 202 can be operated at a temperature in the range of from about 900° C. to about 1600° C. The oxidizer can further comprise a third stage or additional stages, and at least some of the titanium tetrachloride can be introduced to the second stage 202 and/or the third stage and/or any subsequent stage.

At least some of the ultrafine titanium dioxide particles can be introduced to the first stage 200 upstream of the introduction of the titanium tetrachloride to the first stage 200, and/or introduced downstream of the introduction of the titanium tetrachloride to the first stage 200, and/or at least some of the ultrafine titanium dioxide particles can be combined with the titanium tetrachloride prior to the introduction of the titanium tetrachloride to the first stage 200. Additionally, at least some of the ultrafine titanium dioxide particles can be combined with the oxygen prior to the introduction of the oxygen to the first stage 200.

At least some of the oxygen can be introduced to the second stage 202 via lines 206 and 212, and at least some of the ultrafine titanium dioxide particles can be introduced to the second stage 202 via lines 208 and 214. At least some of the ultrafine titanium dioxide particles can be combined with the titanium tetrachloride prior to the introduction of the titanium tetrachloride to the second stage 202, and/or at least some of the ultrafine titanium dioxide particles can be combined with the oxygen prior to the introduction of the oxygen to the second stage 202. A first stage effluent from first stage 200 can be introduced to second stage 202 via line 216. An oxidizer effluent 218 comprising a titanium dioxide product having titanium dioxide particles is removed from second stage 202 (or the third or an additional stage); and the titanium dioxide product can be separated from the oxidizer effluent 218 via line 220. In addition, at least some of the ultrafine titanium dioxide particles can be introduced to subsequent optional stages three, four, etc. . . . of the oxidizer as a part of the agent.

A target median titanium dioxide particle size can be established, and the manufacturing costs can be lower and/or the rate of production of the titanium dioxide product can be higher when using a method in accordance with the presently disclosed and claimed inventive concept(s) as compared to the manufacturing costs and/or rate of production of a second titanium dioxide product produced by a method which is the same as that used to produce the titanium dioxide product, but without the introduction of the ultrafine titanium dioxide particles to the oxidizer.

A target titanium dioxide rate of production can be established, and the manufacturing costs can be lower and/or the median titanium dioxide particle size can be lower and/or the particle size distribution can be narrower for a titanium dioxide product produced using a method in accordance with the presently disclosed and claimed inventive concept(s) as compared to a third titanium dioxide product produced by a method which is the same as that used to produce the titanium dioxide product, but without the introduction of the ultrafine titanium dioxide particles to the oxidizer.

With reference to FIGS. 1 and 2, a Group 1a metal compound can also be introduced (which can be in a controlled manner) into the oxidizer 100 as a part of the agent via line 112, or to first stage 200 or second stage 202 via lines 222 and/or 224, and can be in an amount up to about 1000 ppmw, based on the total weight of the titanium dioxide particles produced in step b) above. In addition, at least some of the Group 1a metal compound can be introduced to subsequent optional stages three, four, etc. . . . of the oxidizer as a part of the agent. The Group 1a metal compound and ultrafine titanium dioxide particles can be introduced to the oxidizer 100 in a combined amount of about 10 ppmw to about 1000 ppmw, or about 10 ppmw to about 700 ppmw or about 20 ppmw to about 500 ppmw, based on the total weight of the titanium dioxide particles produced in step b) above. The introduction of the ultrafine titanium dioxide particles can reduce the amount of the Group 1a metal compound required in order to provide sufficient particle size control.

In either the case where a Group 1a metal compound is present in the oxidizer or is not present the titanium dioxide product produced by a method in accordance with the presently disclosed and claimed inventive concept(s) has lower manufacturing costs and/or a lower median titanium dioxide particle size and/or a narrower particle size distribution as compared to a fourth titanium dioxide product produced by a method which is the same as that used to produce the titanium dioxide product, but without the introduction of the ultrafine titanium dioxide particles to the oxidizer.

The Group 1a metal compound can be a Group 1a metal halide, and the Group 1a metal halide can be selected from the group consisting of KCl, CsCl, and combinations thereof. The amount of Group 1a metal compound introduced can be from about 10 ppmw to about 950 ppmw, or about 10 ppmw to about 650 ppmw, or about 20 to about 450 ppmw, based on the total weight of the titanium dioxide particles produced in step b) above.

When a Group 1a metal is introduced to the oxidizer along with the ultrafine titanium dioxide particles as a part of the agent, the weight ratio of the Group 1a metal (whether KCl, CsCl or a combination thereof) to the ultrafine titanium dioxide particles can range from greater than 0 to less than 1, or from greater than 0 to about 0.1, or from about 0.1 to about 0.2, or from about 0.2 to about 0.3, or from about 0.3 to about 0.4, or from about 0.4 to about 0.5, or from about 0.5 to about 0.6, or from about 0.6 to about 0.7, or from about 0.7 to about 0.8, or from about 0.8 to about 0.9, or from about 0.9 to less than 1, or up to about 0.1, or up to about 0.2, or up to about 0.3, or up to about 0.4, or up to about 0.5, or up to about 0.6, or up to about 0.7, or up to about 0.8, or up to about 0.9, or up to less than 1.

In accordance with another embodiment of the presently disclosed and claimed inventive concept(s), a method for controlling particle size of titanium dioxide particles comprises, consists of, or consists essentially of:

a) introducing the titanium tetrachloride and the oxygen to the oxidizer;

b) introducing the agent comprising ultrafine titanium dioxide particles to the oxidizer in a controlled manner; and

c) oxidizing at least some of the titanium tetrachloride with at least some of the oxygen in the presence of the agent to form an oxidizer effluent comprising the titanium dioxide product having titanium dioxide particles, and wherein the introduction of the agent to the oxidizer is controlled such that, at a target titanium dioxide rate of production, the titanium dioxide product has a lower median titanium dioxide particle size and/or a narrower particle size distribution as compared to a second titanium dioxide product produced by a method which is the same as that used to produce the titanium dioxide product, but without the controlled introduction of the agent to the oxidizer.

The conditions, descriptions and embodiments described above apply to this embodiment.

In accordance with another embodiment of the presently disclosed and claimed inventive concept(s), a method for producing titanium dioxide particles comprises, consists of, or consists essentially of:

a) introducing the oxygen and the first titanium tetrachloride feed comprising titanium tetrachloride to a first stage of an oxidizer having at least two stages;

b) oxidizing at least some of the first titanium tetrachloride feed with at least some of the oxygen in the first stage to form a first stage effluent;

c) introducing the first stage effluent to a second stage of the oxidizer;

d) introducing a second titanium tetrachloride feed comprising titanium tetrachloride to the second stage;

e) oxidizing at least some of the second titanium tetrachloride feed with at least some of the oxygen from the first stage effluent in the second stage to form a second stage effluent comprising a titanium dioxide product, wherein the titanium dioxide product comprises the titanium dioxide particles; wherein the agent comprising ultrafine titanium dioxide particles is introduced to at least one stage of the oxidizer; and

f) separating at least some of the titanium dioxide product from the second stage effluent.

The conditions, descriptions and embodiments described above apply to this embodiment.

### EXAMPLE

### Blends of Ultrafine TiO₂ and Cesium Chloride

CsCl salt was mixed with ultrafine TiO₂ (specifically, a suspension of peptized metatitanic acid in water). Transmission Electron Microscopy images showed that the ultrafine TiO₂ consisted of crystallites of approximately 2.5 nm to 4.0 nm, forming agglomerates of approximately 40 nm to 50 nm. The addition rate of cesium chloride was set at about 50 ppmw relative to the rate of production of titanium dioxide product from the oxidizer, and the addition rate of ultrafine TiO₂ was varied between 45 ppmw and 150 ppmw relative to the rate of production of titanium dioxide product from the oxidizer. This was achieved by maintaining the rate of the oxidizer constant, setting the concentration of the cesium chloride solution to 58 g/L, and varying the concentration of the ultrafine TiO₂ in the cesium chloride and ultrafine TiO₂ blend between 50 g/L and 180 g/L.

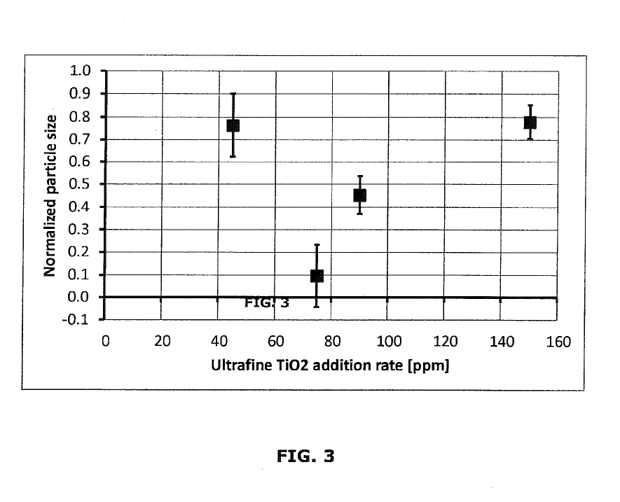

The particle size of the titanium dioxide product from the oxidizer was measured by light scattering. The median particle size of the titanium dioxide products produced during the testing was normalized, so that the lowest value of the median particle sizes of all samples retrieved during the test was attributed a value of 0, and the highest value of the median particle sizes was attributed a value of 1. FIG. 3 shows the normalized average value for the median particle size for addition rates of the Ultrafine TiO₂ of 45 ppm, 75 ppm, 90 ppm and 150 ppm. The error bars indicate the 95% confidence interval of the normalized average value of the median particle size for each addition rate of the ultrafine TiO2. The results show that as the addition rate of Ultrafine TiO₂ is increased from 45 ppmw up to 75 ppmw, the median particle size of the titanium dioxide product produced by the oxidizer decreases relative to the amount of titanium dioxide product from the oxidizer; and the median particle size of the titanium dioxide product from the oxidizer increases for Ultrafine TiO₂ addition rates above 75 ppmw up to 150 ppmw, relative to the amount of titanium dioxide product from the oxidizer.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, unless expressly stated otherwise, the term “about” as used herein is intended to include and take into account variations due to manufacturing tolerances and/or variations in process control.

Many modifications and variations of the presently claimed and disclosed inventive concepts can be made without departing from its spirit and scope, as will be apparent to those skilled in the art. The specific embodiments described herein are offered by way of example only, and the presently claimed and disclosed inventive concepts are to be limited only by the terms of the appended claims, along with the full scope of equivalents to which such claims are entitled.

What is claimed is:

1. A method for producing titanium dioxide particles comprising:
a) introducing titanium tetrachloride, oxygen, and an agent to an oxidizer; wherein the agent comprises ultrafine titanium dioxide particles; and wherein the ultrafine titanium dioxide particles are in a form selected from the group consisting of anatase, rutile, amorphous, and combinations thereof; and
b) oxidizing at least some of the titanium tetrachloride with at least some of the oxygen in the presence of the agent to form an oxidizer effluent comprising a titanium dioxide product having titanium dioxide particles.

2. The method of claim 1 wherein the agent provides an activity selected from the group consisting of nucleating activity, non-agglomerating activity, and both nucleating activity and non-agglomerating activity.

3. The method of claim 1 wherein:
c) at least some of the titanium dioxide product is separated from the oxidizer effluent.

4. The method of claim 1 wherein the oxidizer is operated at a temperature in the range of from about 900° C. to about 1600° C.

5. The method of claim 1 wherein the ultrafine titanium dioxide particles are introduced to the oxidizer in an amount of from about 50 ppmw to about 100 ppmw, based on the total weight of the titanium dioxide particles produced in step b).

6. The method of claim 1 wherein, at a target median titanium dioxide particle size, the rate of production of the titanium dioxide product is higher as compared to the rate of production of a second titanium dioxide product produced by a method which is the same as that used to produce the titanium dioxide product, but without the introduction of the ultrafine titanium dioxide particles to the oxidizer.

7. The method of claim 1 wherein, at a target titanium dioxide rate of production, the titanium dioxide product has a lower median titanium dioxide particle size and/or a narrower particle size distribution as compared to a third titanium dioxide product produced by a method which is the same as that used to produce the titanium dioxide product, but without the introduction of the ultrafine titanium dioxide particles to the oxidizer.

8. The method of claim 1 wherein the oxidizer comprises at least a first stage and a second stage, and wherein at least some of the titanium tetrachloride and at least some of the oxygen are introduced to the first stage.

9. The method of claim 8 wherein the oxidizer further comprises a third stage, and wherein at least some of the titanium tetrachloride is introduced to: i) the second stage or ii) the third stage or iii) both the second stage and the third stage.

10. The method of claim 8 wherein at least some of the ultrafine titanium dioxide particles are introduced to the first stage.

11. The method of claim 8 wherein at least some of the titanium tetrachloride and at least some of the oxygen are introduced to the second stage.

12. The method of claim 1 wherein a Group 1a metal compound is also introduced as a part of the agent into the oxidizer in an amount from about 10 ppmw to about 950 ppmw, based on the total weight of the titanium dioxide particles produced in step b).

13. The method of claim 12 wherein the Group 1a metal compound is a Group 1a metal halide.

14. A method for controlling particle size of titanium dioxide particles comprising:
a) introducing titanium tetrachloride and oxygen to an oxidizer;
b) introducing an agent comprising ultrafine titanium dioxide particles to the oxidizer in a controlled manner, wherein the ultrafine titanium dioxide particles are in a form selected from the group consisting of anatase, rutile, amorphous, and combinations thereof; and
c) oxidizing at least some of the titanium tetrachloride with at least some of the oxygen in the presence of the agent to form an oxidizer effluent comprising a titanium dioxide product having titanium dioxide particles, and wherein the introduction of the agent to the oxidizer is controlled such that, at a target titanium dioxide rate of production, the manufacturing costs are lower and/or the titanium dioxide product has a lower median titanium dioxide particle size and/or a narrower particle size distribution as compared to a second titanium dioxide product produced by a method which is the same as that used to produce the titanium dioxide product, but without the controlled introduction of the agent to the oxidizer.

15. The method of claim 14 wherein the agent provides an activity selected from the group consisting of nucleating activity, non-agglomerating activity, and both nucleating activity and non-agglomerating activity.

16. The method of claim 14 wherein the oxidizer is operated at a temperature in the range of from about 900° C. to about 1600° C.

17. The method of claim 14 wherein the ultrafine titanium dioxide particles of the agent are introduced to the oxidizer in an amount of from about 50 ppmw to about 100 ppmw, based on the total weight of the titanium dioxide particles produced in step c).

18. The method of claim 14 wherein at least a portion of the ultrafine titanium dioxide particles of the agent are agglomerated ultrafine titanium dioxide particles having a median size range from about 2 nm to about 150 nm.

19. The method of claim 18 wherein at least a portion of the ultrafine titanium dioxide particles of the agent are maintained as discrete ultrafine titanium dioxide particles having a median discrete particle size from about 1 nm to about 60 nm.

20. The method of claim 14 wherein the oxidizer comprises at least a first stage and a second stage, and wherein at least some of the titanium tetrachloride and at least some of the oxygen are introduced to the first stage.

21. The method of claim 20 wherein the oxidizer further comprises a third stage, and wherein at least some of the titanium tetrachloride is introduced to: i) the second stage or ii) the third stage or iii) both the second stage and the third stage.

22. The method of claim 20 wherein at least some of the titanium tetrachloride and at least some of the oxygen are introduced to the second stage.

23. The method of claim 20 wherein at least some of the agent is introduced to the first stage.

24. The method of claim 14 wherein a Group 1a metal compound is also introduced as a part of the agent into the oxidizer in a controlled manner in an amount from about 10 ppmw to about 950 ppmw, based on the total weight of the titanium dioxide particles produced in step c).

25. The method of claim 24 wherein the Group 1a metal compound is a Group 1a metal halide.

26. A method for producing titanium dioxide particles comprising:
a) introducing oxygen and a first titanium tetrachloride feed comprising titanium tetrachloride to a first stage of an oxidizer having at least two stages;
b) oxidizing at least some of the first titanium tetrachloride feed with at least some of the oxygen in the first stage to form a first stage effluent;
c) introducing the first stage effluent to a second stage of the oxidizer;
d) introducing a second titanium tetrachloride feed comprising titanium tetrachloride to the second stage;
e) oxidizing at least some of the second titanium tetrachloride feed with at least some of the oxygen from the first stage effluent in the second stage to form a second stage effluent comprising a titanium dioxide product, wherein the titanium dioxide product comprises the titanium dioxide particles; wherein an agent comprising ultrafine titanium dioxide particles is introduced to at least one stage of the oxidizer; and
f) separating at least some of the titanium dioxide product from the second stage effluent.

27. The method of claim 26 wherein the agent provides an activity selected from the group consisting of nucleating activity, non-agglomerating activity, and both nucleating activity and non-agglomerating activity.

28. The method of claim 26 wherein the ultrafine titanium dioxide particles of the agent are in a form selected from the group consisting of anatase, rutile, amorphous, and combinations thereof.

29. The method of claim 26 wherein the ultrafine titanium dioxide particles of the agent are introduced to the oxidizer in an amount of from about 50 to about 100 ppmw, based on the total weight of the titanium dioxide particles produced in step e).

30. The method of claim 26 wherein at least a portion of the ultrafine titanium dioxide particles of the agent are agglomerated ultrafine titanium dioxide particles having a median size range from about 2 nm to about 150 nm.

31. The method of claim 30 wherein at least a portion of the ultrafine titanium dioxide particles of the agent are maintained as discrete ultrafine titanium dioxide particles having a median discrete particle size from about 1 nm to about 60 nm.

32. The method of claim 26 wherein the first stage is operated at a temperature in the range of from about 900° C. to about 1600° C., and the second stage is operated at a temperature in the range of from about 900° C. to about 1600° C.

33. The method of claim 26 wherein a Group 1a metal compound is introduced as a part of the agent to at least one stage of the oxidizer in an amount from about 10 ppmw to about 950 ppmw, based on the total weight of the titanium dioxide particles produced in step e).

34. The method of claim 33 wherein the Group 1a metal compound is a Group 1a metal halide.
